(19) United States
(12) Patent Application Publication
(10) Pub. No.: US 2009/0006155 A1
(43) Pub. Date: Jan. 1, 2009

(54) METHOD AND SYSTEM FOR GENERATING INFORMATION ASSOCIATION MATRIX

(76) Inventor: Kenichiro WATANABE, Tachikawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/018,447

(22) Filed: Jan. 23, 2008

(30) Foreign Application Priority Data
Jan. 25, 2007 (JP) 2007-014490

(51) Int. Cl. G06Q 10/00

(52) U.S. Cl. 705/7

(57) ABSTRACT

A method for generating an information association matrix for assisting service design includes the steps of extracting a DFD number corresponding to an indication number displayed on the matrix from a DFD set master and storing the DFD number in a sub-task master; extracting an action number corresponding to the indication number from an action set master and storing the action number in a setting table; extracting a sub-task name corresponding to the indication number from a DFD set master and storing the sub-task name to a position on a diagonal of the matrix; and reading an action number stored in the setting table, acquiring an information transmitting service DFD number, an information transmitted service DFD number and an information name each corresponding to the action number from an action master and storing the information name to the matrix.

### INCORPORATION BY REFERENCE

The present application claims priority from Japanese application JP2007-014490 filed on Jan. 25, 2007, the content of which is hereby incorporated by reference into this application.

### BACKGROUND OF THE INVENTION

1. Field of the Invention

This invention relates to a technology for generating an information association matrix (definition of which will be described elsewhere) that will be useful for grasping in detail existing services in enterprise actions and designing in detail new services.

2. Description of the Related Art

In “grasping/designing of enterprise services” and “grasping/designing of information flow among services” executed in service design and system basic design as important processes in an in-house system configuration, difficulty in design is always encountered owing to multiple branches of service actions. U.S. Pat. No. 5,493,489A (Tamaki et al.) discloses a technology for designing enterprise services and U.S. Pat. No. 7,065,741B (Shozui et al.) discloses a concrete technology for designing information flows on the basis of the former design technology. These “Enterprise Information Flow Defining Method” and “Enterprise Information Flow Processing Method and Design Form Generating Method” are the prior art technologies corresponding to the present invention.

On the premise that knowledge is given as to which services exist inside an enterprise is given, the prior art technology is directed to define which information flows among the services. When a certain service (task: definition of which will be given later) “order acceptance” exists, for example, there are various patterns of order accepting processes depending on the kind of goods and order receiving sections according to the prior art. (Each of these patterns will be called an “action” or an “action pattern”). It will be assumed hereby that n actions of the normal order accepting processes exist while m actions of irregular processes exist, too. The prior art grasps all the action patterns n+m and displays them on a sheet of an information association matrix.

### SUMMARY OF THE INVENTION

Generally, service design and system configuration are executed in the following steps.

(1) problem analysis
(2) service design
(3) system basic design
(4) system detailed design
(5) system development
(6) combination test
(7) comprehensive test

The technology according to the invention is mainly used in (2) service design and (3) system basic design. The process is generally referred to as “upstream process” in system engineering and is said to be the most bottleneck process in constituting the information system as a tool necessary for service reformation. One of the reasons why this process becomes bottlenecked resides in the difficulty that the flow between one service and another is not easy to grasp appropriately and hence, ideal design is difficult. This is the very problem the invention is directed to solve.

To define the flow of information inside an enterprise in the process as the utilization object of the present technology, the following procedure must be taken. The present invention is an invention relating to a technology for these procedures and an information processing unit for accomplishing the technology.
Procedure 1: Grasping/designing of services inside enterprise
Procedure 2: Grasping/designing of flow of information among services

In the prior art technology, the procedure 1, i.e. grasping/designing of information flow inside an enterprise, is a pre-requisite knowledge. In other words, the procedure 1 exists as the knowledge of operators and the prior art technology is a technology of generating an information association matrix in accordance with the procedure 2. However, when a service is practically designed (by executing the procedure 2) and a necessary information flow inside an enterprise is grasped/designed, designing is generally very difficult owing to multiple branches of service actions. For, because the knowledge of the procedure 1 is personal, the services cannot be grasped/designed appropriately before utilizing the prior art technology when the information flow inside the enterprise is grasped and designed and the prior art technology cannot be utilized effectively.

To generate a new service flow from the information association matrix generated by the prior art technology, for example, the flow of information that is desired to be known now must be specified and sorted out from among the flows of all information of enormous n+m actions of the information association matrix. Since this is a very difficult work, successful generation of a new service flow (service flow of a specific action) greatly depends on the capability (perception and experience) of a designer (consultant•system engineer) even when one information association matrix representing all the actions can be generated. Therefore, the technology is a service design method that is not much suitable for services in which information association among the services is complicated.

To solve the problem described above, the invention has developed a technology that specifies the cause of multiple branching of the service action and eliminates its cause. To have the invention more clearly understood, the causes for the occurrence of the problem will be analyzed and explained next.

The following three causes make grasping/designing of the services inside the enterprise difficult.

### Cause 1)

Services existing inside the enterprise are very diversified.

### Cause 2)

Services existing inside the enterprise are different from enterprise to another.

### Cause 3)

Services exist not independently but have complicated relations among them.

Among the three causes given above, the cause 3 is the essential cause of multiple branching of the service action. To understand in detail the content of the cause, the explanation will be made as follows. The following explanation uses the basic concept of the modern linguistics and the cause 3 cannot be explained without this basic concept. Unless the following explanation be understood, the problem the present invention handles cannot be essentially understood. Unless the following explanation be understood, the problem the invention is to solve cannot be essentially appreciated.

The “complicated relations” indicated by the cause 3 include the following four factors.

### (Factor 1)

The object the invention “directly” designs is not a service as signifie but a service as signifiant. The deed of designing a new service means reformation of a service. Service reformation starts by assembling a work improvement plan on the desk before a work reform instruction is given by a planner on a production site by raising his voice. In other words, the deed of “grasping” or “designing” the “services existing inside the enterprise” as the signifie (object•content represented by symbol-character) is conducted only through description of the metaphysic signifiant (expression of the symbol-character indicating the signifie) for the services as the signifie existing inside the enterprise. The services as the signifie are reformed on the basis of the design result as the signifiant (To-Be Model, idea, ideal form).

Therefore, the object “directly” designed by the invention is not the service as the signifie but the service as the signifiant.

### (Factor 2)

Signifie corresponding to signifiant cannot be determined primarily. The service as the metaphysical signifian cannot be determined primarily for the signifie as “service existing inside enterprise” that is a concrete existence. For instance, various signifians such as “procurement”, “buying-in”, “purchase”, etc, are given to the deed of acquiring a matter in exchange for money. This is one of the essential properties of “language” in that signifiant for signifie cannot be primarily determined.

### (Factor 3)

Signifian does not primarily designate signifie. The service as the metaphysical signifiant does not primarily designate signifie as “service existing inside enterprise”. For example, the signifie cannot primary represent whether or not signifiant “process management” contains an action for controlling cost-up occurring in a production process or an action of designing the production process itself or an action of preparing setup required for the production process or an action of planning a production quantity for a specific period, or the like. This results from one of the essential properties of “language” in that signifiant does not primarily designate signifie.

### (Factor 4)

Signifiant is not independent (is not an independent entity). The service as a certain signifiant can be defined only when mutual definition is made with services as other signifiants. Let's consider, for example, two signifiants, “production” and “production plan”. Only when signifie corresponding to the signifiant “production” is specified, the signifiant “production plan” as an action of planning “production” can be defined. To let the signifiant “production” mean only “work of creation”, the signifiant functions as a signifiant only after the signifiant “production plan” is defined and then definition “action for executing production on basis of production plan” is made. Otherwise, it is not clear whether or not the signifiant “production” contains “action of planning” and the signifiant does not function as a signifiant. For, the signifiants can be defined only after mutual definition is made among them, and this is also one of the essential properties of “language” that nothing can be defined without definition of other signifiants.

On the basis of the explanation given above, the objects of the invention are as follows.

### (1) Establishment of Service Designing Method:

The invention is directed to establish a method that eliminates the problem for utilizing the prior art technology, and appropriately grasps and designs services.

(2) Establishment of Information Flow Defining Method Compatible with the Service Designing Method by Problem 1 Described Above:

The service grasping/designing method established by the problem 1 is not strictly compatible with the existing information flow defining method. To overcome this mal-matching, the invention establishes an information flow defining method compatible with the service grasping/designing method of the problem 1.

In an information association matrix generation apparatus for generating an information association matrix for assisting detailed grasping of existing services in enterprise actions and detailed designing of new services, the invention stores information by using an action number collected for a plurality of sub-tasks (definition of which will be later described) and generates the information association matrix.

Concretely speaking, the information association matrix generation apparatus according to the invention grasps information association among complicated services (branching of information among services resulting from difference of management subject as action object (definition of which will be later described)) and then generates the information association matrix limited to actions selected arbitrarily. When a service flow of only normal processing not containing an irregular processing is to be generated, for example, n actions are designated and the flow of information related to them can be picked up and outputted to the information association matrix. Needless to say, it is also possible to designate one action and to display the flow of its information. In consequence, sorting for generating a service flow from the information association matrix becomes unnecessary and generation of the service flow for each action scene becomes by far easier. Therefore, the invention can design services and the flow of information even when the information association is complicated among the services.

According to the invention, it is now possible to establish a method for appropriately grasping and designing services when service design is made.

Other objects, features and advantages of the invention will become more apparent from the following description of the embodiments of the invention taken in conjunction with the accompanying drawings.

### BRIEF DESCRIPTION OF THE DRAWINGS

FIG. 1 is a schematic view showing a construction of an information association matrix generation apparatus according to an embodiment of the invention;

FIG. 2 is a flowchart showing a procedure of an information association matrix generation process in the embodiment of the invention;

FIG. 3 is a block view showing a construction of a master group 001-06 and a program 001-07 in the embodiment of the invention;

FIG. 4 is a flowchart showing a procedure of signifiant definition in the embodiment of the invention;

FIG. 5 is a table showing an example of a signifiant model in the embodiment of the invention;

FIG. 6 is a flowchart showing a procedure of service function definition in the embodiment of the invention;

FIG. 7 is a table showing an example of a service action analysis matrix in the embodiment of the invention;

FIG. 8 is a flowchart showing a procedure of action definition in the embodiment of the invention;

FIG. 9 is a flowchart showing an example of an action flow in the embodiment of the invention;

FIG. 10 is a flowchart showing a procedure of information investigation according to the embodiment of the invention;

FIG. 11 is a flowchart showing a process of a DFD (Data Flow Diagram) number collection program according to the embodiment of the invention;

FIG. 12 is a flowchart showing a process of an action number extraction program according to the embodiment of the invention;

FIG. 13 is a flowchart showing a procedure of DFD diagonal setting program according to the embodiment of the invention;

FIG. 14 is a flowchart showing a procedure of DFD generation program according to the embodiment of the invention;

FIG. 15A is a diagram showing an example of an information association matrix (left-hand half) according to the embodiment of the invention;

FIG. 15B is a diagram showing an example of the information association matrix (right-hand half) according to the embodiment of the invention;

FIG. 16 is a table showing a master of a service function third hierarchy “sub-function” information according to the embodiment of the invention;

FIG. 17 is a table showing a master of a service function fourth hierarchy “task” information according to the embodiment of the invention;

FIG. 18 is a table showing a master of a service function fifth hierarchy “sub-task” information according to the embodiment of the invention;

FIG. 19 is a table showing an example of a DFD set master according to the embodiment of the invention;

FIG. 20 is a table showing an example of an indication master according to the embodiment of the invention;

FIG. 21 is a table showing an example of an action set master according to the embodiment of the invention;

FIG. 22 is a table showing an example of a master defining the flow of information between service functions for each action number according to the embodiment of the invention;

FIG. 23 is a table showing an example of a control table according to the embodiment of the invention; and

FIG. 24 is a table showing an example of an action set table according to the embodiment of the invention.

### DESCRIPTION OF THE EMBODIMENTS

An information association matrix generation apparatus according to an embodiment of the invention, that is directed to generate an information association matrix for assisting detailed grasping of existing services in enterprise actions and detailed designing of new services, will be hereinafter explained.

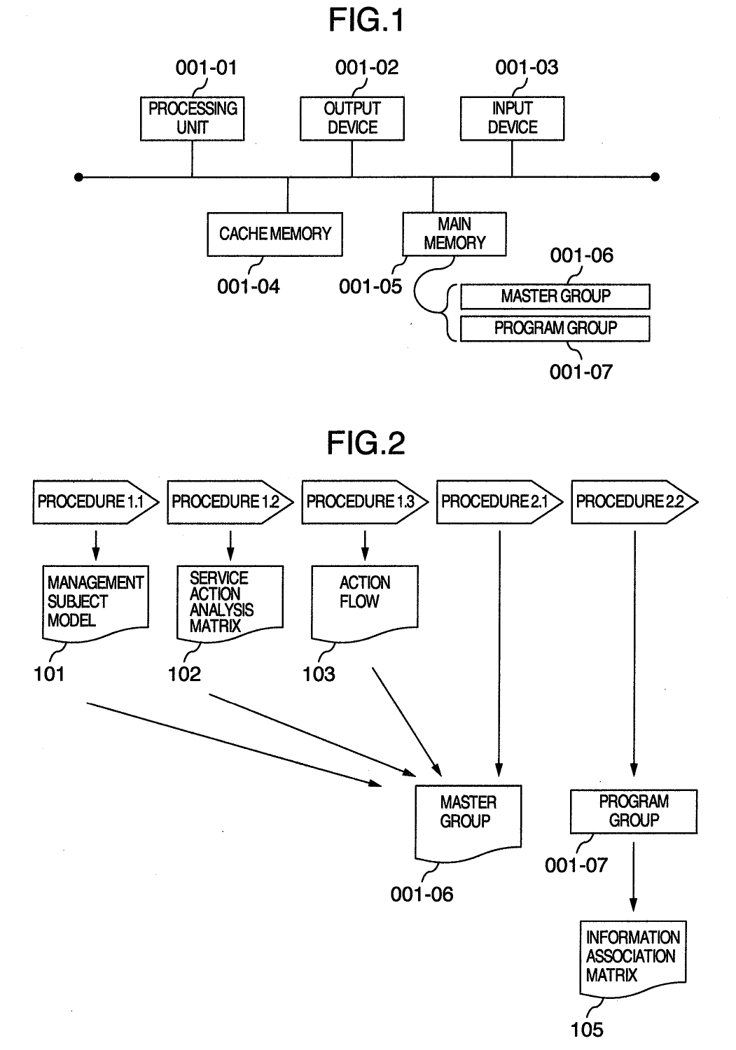

FIG. 1 shows a schematic construction of an information association matrix generation apparatus according to an embodiment of the invention. The present invention is an invention relating to a technology, and an apparatus for accomplishing the technology, that are utilized in the processes, i.e. “grasping/designing of enterprise services” (procedure 1) and “grasping/designing of information flow among services” (procedure 2) executed in (2) service designing and (3) system basic design described already. The apparatus includes a master group 001-06 having a data structure defined by this technology and a program group 001-07 using data of the master as input information each of which is stored in a main memory 001-05 of an ordinary information processing unit such as a personal computer as shown in FIG. 1.

### <Relation Between Invented Apparatus and Execution Procedure>

The detailed procedures of the “grasping/designing of enterprise services” (procedure 1) and “grasping/designing of information flow among services” (procedure 2) will be explained in detail.
Procedure 1: grasping/designing of enterprise service
Procedure 1.1: definition of signifiant
Procedure 1.2: definition of service function
Procedure 1.3: definition of action
Procedure 2: grasping/designing of information flow among services
Procedure 2.1: definition of information flowing between sub-tasks
Procedure 2.2: generation of information association matrix

These procedures as well as the relation between the master group 001-06 having the data structure defined by the present technology and the program group 001-07 utilizing the master as the object of this embodiment will be explained.

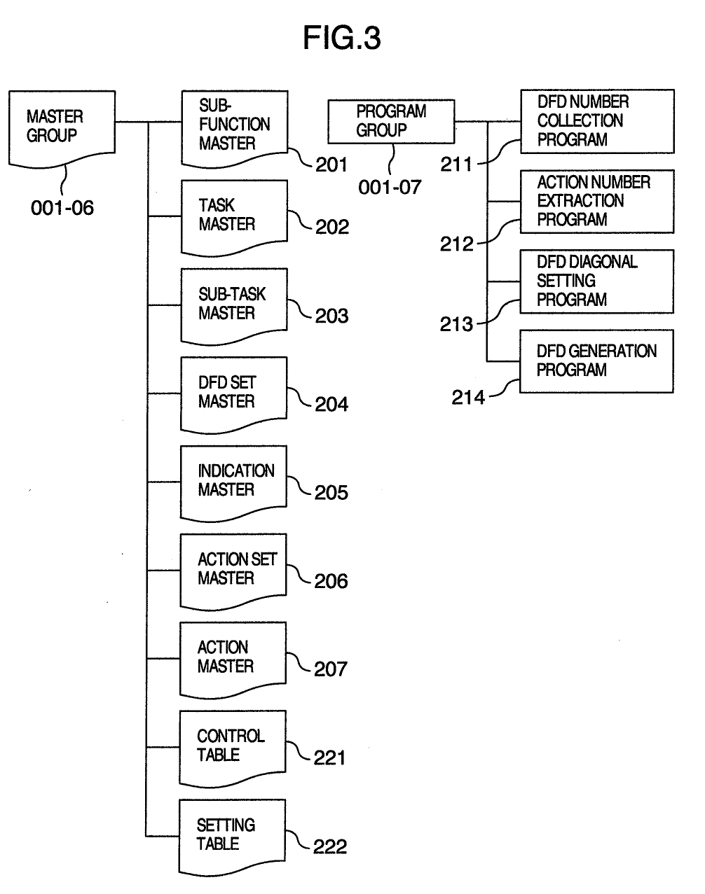

FIG. 2 is a flowchart showing the procedure of an information association matrix generation process in this embodiment. The procedures 1.1 to 1.3 and the procedure 2.1 are those procedures which generate various kinds of documents (101, 102 and 103 in FIG. 2) expressing enterprises services in accordance with the procedures defined in the present technology and the flow of information between the services and store the master group 001-06 in the main memory (001-05 in FIG. 1) having the data structure defined by the present technology on the basis of the documents.

The procedure 2.2 is a flow inside the information processing system in which a processing unit (001-01 in FIG. 1) generates an information association matrix (global DFD (Data Flow Diagram)) 105 as a design of the flow of information among enterprise services by using a program that operates by utilizing the master of the procedure 2.2. As a result of this procedure 2.2, a design information association matrix among the services inside the enterprises as the object of the present technology is generated.

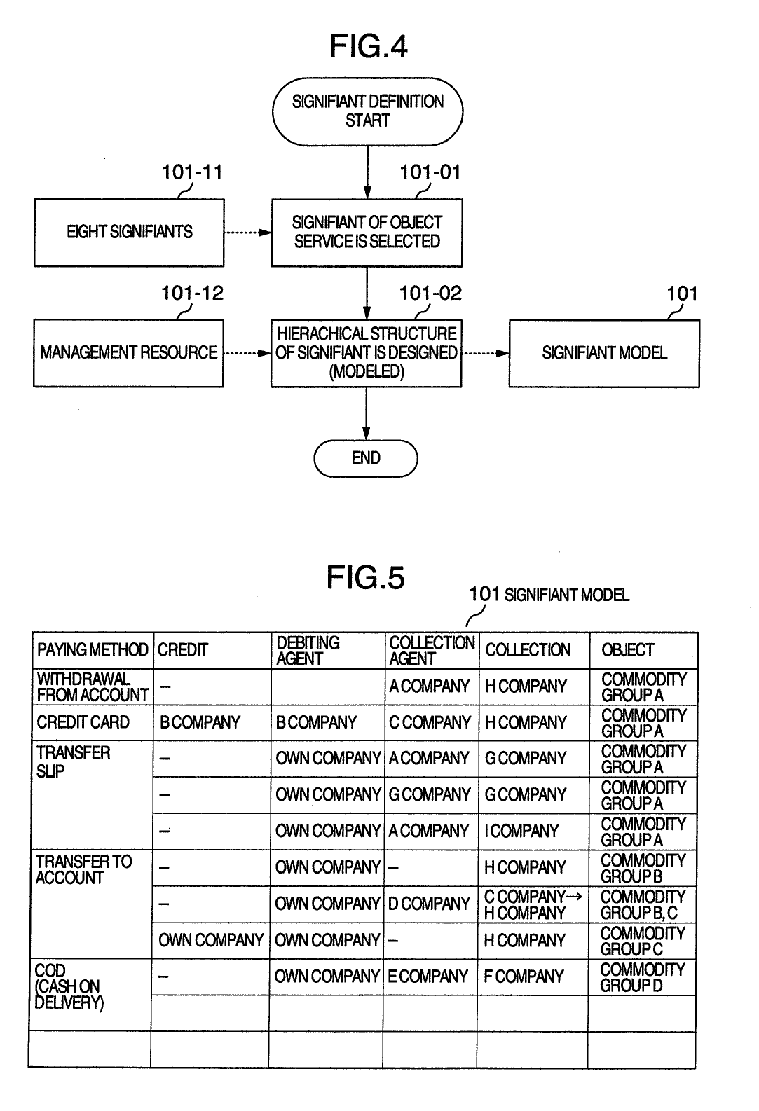

FIG. 3 shows the constructions of the master group 001-06 and the program group 001-07 in this embodiment. The constructions of the master group 001-06 having the data structure used in the embodiment and the program group 001-07 utilizing the master will be explained next.

The master group 001-06 having the data structure defined in the embodiment includes seven kinds of masters that are initially set and two kinds of tables the content of which is updated whenever a program is operated.

The masters include three kinds of masters (201, 202, 203) defining service functions for each hierarchy (third hierarchy sub-function, fourth hierarchy task, fifth hierarchy sub-task; definition of hierarchy will be later explained), an indication master 205 for setting the unit that is desired to be displayed on the information association matrix, a DFD (Data Flow Definition) set master 204 for setting the service function (fourth hierarchy sub-task) for each unit to be displayed, an action master 206 for setting an action (unit of flow of information; definition of action will be later explained) on the information association matrix for each unit to be displayed, and an action master 207 defining the flow of information between the services in each action. Incidentally, a master for a first hierarchy enterprise and a second hierarchy function may be disposed, too, whenever necessary.

The tables include a control table 221 for designating the unit which is desired to be displayed on the information association matrix and a setting table 222 for listing up the actions that are to be displayed on the information association matrix. Incidentally, it is only the control table 221 that is set by an operator whenever the processing unit (001-01 in FIG. 1) is operated in the procedure 2.2 and the setting table 222 is automatically generated and updated by the processing unit.

In this embodiment, the program described above for causing the computer to operate as a processing unit for executing the action number collection process, the DFD number collection process, the action number extraction process, the DFD diagonal setting process and the DFD generation process is recorded to a recording medium such as CD-ROM, is stored in a magnetic disk, is then loaded to a memory and is executed. Recording media other than the CD-ROM may be used as the recording medium for recording the program. The program may be installed to and used by the computer from the recording medium. Alternatively, it is possible to gain access to the recording medium through a network and to use the program.

### <Execution Procedure>

Hereinafter, individual procedures will be explained in further detail.

### <Procedure 1.1 Definition of Signifiant>

Business as signifie is defined from a management resource as signifie as an action object of the service. The relation between a certain signifie and another signifie is mapped by a language to a relation between a certain signifie and another signifie having a similar structure. Mapping of the relations is not primary owing to the factors 2 and 3 explained already and some contrivances are necessary.

Therefore, this embodiment first defines signifiant as the management subject for the management resource as signifie that an enterprise has.

There are eight kinds of management resources the enterprise has and a detailed structure of the management resource (signifie) is defined as management subject (signifiant).

The eight kinds of the management subjects are as follows.

### (1) Market:

Outside of the enterprise the main object of which is sale: customers, final consumers, sales route, etc.
   (2) Business connection•various organizations:
dealers, affiliates, cooperative companies, shareholders, banks, auditors

### (3) Environment:

Local society, society, system, laws, etc.
   (4) Main object:
Sources of values that the enterprises offer to customers. Object that the enterprises deal as legitimate occupation

### (5) Technology:

Technology, know-how, etc, for the enterprise to produce and offer the main object and to improve added values.

### (6) Materials:

Facilities, setups, etc, required for the enterprise for business actions.
   (7) Human resources:
Personnel, organizations, etc, necessary for business actions

### (8) Money:

Assets, liabilities, capital, sales, profits, etc, necessary for business actions

Among these eight kinds of information, 1 to 3 are “market knowledge” about external entities of the enterprise, 4 to 6 are “product knowledge” about the structure of the main object and the method of imparting the added values and 7 and 8 are “organization knowledge” as knowledge of the organization structure inside the enterprise.

### <Procedure 1.2: Definition of Service Function>

The signifiant “service function” having the management subject as the action object is defined by the signifiant management subject defined by the procedure 1.1.

The signifiant “service function” is defined with a hierachical structure. This originates from versatility and hierarchy of the signifie management resources as the action object of the signifie service. In this embodiment, the signifiant “service function” is defined by the six hierarchies in the following way. The hierarchies originate from the difference of the signifiant management subjects as the action object of the signifiant “service function”.

Incidentally, the order of description in each hierarchy is the name of hierarchy, the name of the service function and definition (e.g. service function name, management subject as the action object).
First hierarchy: enterprise: business (e.g. publication, main object=publications)
Second hierarchy: function (e.g. sale, customers)
Third hierarchy: sub-function (e.g. credit sale management, credit)
Fourth hierarchy: task (e.g. demand for payment, unpaying customers of credit sale)
Fifth hierarchy: sub-task (issue of debit note, sheet for debit note)
Six hierarchy: Operation (e.g. credit-debit offset operation, credit data, debit data)

The second to fourth hierarchies are “logic model” having the management subject of an abstract level as their action objects and the fifth and sixth hierarchies are “physical model” having a physical management subject as their action object. The “service model” (service flows are generally used) designed by the system basic design is defined by the fifth and sixth hierarchies. In other words, the problem to which the present embodiment is directed and which is described already is paraphrased to difficulty of detailing from the fourth hierarchy (task) to the fifth hierarchy (sub-task). The present invention is an invention that makes contrivances in detailed classification from the fourth hierarchy (task) to the fifth hierarchy (sub-task).

The hierachical structure of the service function depends on the hierachical structure of the management subject. Therefore, the operation of detailing the service function from the logical model to the physical model (detailing from the fourth hierarchy to the fifth hierarchy) generally means detailing from the signifiant “service function” handled in the service design in the service reformation to the signifiant “service function” to the “physical level” handled in the system basic design. Whether or not the system configuration can be successfully achieved in accordance with the object and the business form determined in the service reformation depends on whether or not the detailing operation described above can be executed appropriately.

In this embodiment, therefore, the procedure 1.1 “definition of management subject” is executed and definition of the signifiant management subject is executed as the action object of the signifiant “service function” as the preparation for grasping the hierachical structure of the signifiant “service function”. The service action analysis matrix utilized by this embodiment is the technology for defining the signifiant “service function” as the action object with the definition of the signifiant management subject.

To detail the fourth hierarchy (task) of the signifiant “service function” to the fifth hierarchy (sub-task), it is necessary to pay careful attention to the difference of the signifiant management subject as the action object of the task. In the same task “debiting”, for example, the flow of the action is finely divided depending on the difference of various kinds of management subjects (authorization agent, debiting agent, factering agent) related to “business relations/organizations”. In this embodiment, the flow of the divided tasks is defined as “action”.

The task can be decomposed for each action into four steps of “preparation (input)→process→check→registration (output)”. The debiting work for a customer desiring payment through a debiting agent A, for example, involves the four steps of “extraction of debiting data” (preparation: input) for debiting information→“credit sale-debiting-collection/offsetting operation” (process: process)→“confirmation of offsetting error” (check)→“transmission of debiting data to A company dedicated line” (registration: output). This flow is the action when the management subject of the “debiting agent” for the task “debiting” is the “A company”. “Extraction of debiting data” →“credit sale-debiting-collection/offsetting operation”→“confirmation of offsetting error” →“transmission of debiting data to A company dedicated line” that are hereby defined are the fifth task “sub-task” of the signifiant “service function.

In this way, the embodiment details the signifiant “service function” fourth hierarchy (task) into the fifth hierarchy (sub-task) from the signifiant management subject by using the service action analysis matrix and defines the hierarchies.

It is one of the very important points of this embodiment for solving the problem explained in “Problems to be Solved by the Invention” that the information of the fifth hierarchy “sub-task” is defined by branching of actions owing to branching of the management subject in the fourth hierarchy service function “task”.

### <Procedure 1.3 Definition of Action>

The procedure 1.2 defines the service function but does not define the information flowing among the service functions. The action defined by the procedure 1.2 is only the flow of services inside the task. In contrast, the procedure 1.3 defines the flow of information among the tasks and the flow of information among the actions inside each task as an action flow diagram.

### <Procedure 2.1 Definition of Information Flowing Among Sub-Tasks>

The sub-tasks defined by the service action analysis matrix of the procedure 1.2 are aligned on the diagonal of the information association matrix. In addition to the flow of information among the tasks defined by the action flow diagram, the flow of information among the sub-tasks inside the task is defined for each action number by hearing investigation and is put on the information association matrix.

The term “information association matrix” hereby used means a diagram in which a specific service function is arranged on the diagonal, input information for the service function is put on the transverse line including the service function and output information for the service function is put on the longitudinal line. Incidentally, this information association matrix corresponds to products described in “Enterprise Information Flow Processing Method and Design Form Generating Method” (U.S. Pat. No. 7,065,741B: Shozui et al.).

The action flow diagram describes the flow of information among the actions (among different action numbers) but does not represent the flow of information inside the action (inside one action number). Therefore, to define the flow of information among different sub-tasks, the hearing investigation is necessary besides the procedures 1.1 to 1.3. The information flowing among the fifth hierarchies “sub-tasks” of the signifiant “service function” can be registered to the system of this embodiment from the investigation result.

Setting required for the system of this embodiment to generate the information association matrix is completed by the works up to the procedure 2.1.

### <Procedure 2.2 Generation of Information Association Matrix>

After the works up to the procedure 2.1 are complete, the system utilizing the technology in this embodiment can generate the detailed information association matrix 105 as the final product. Unlike the prior art technology, it is possible to select an arbitrary action and to display the flow of only the information relating to that action for displaying the detailed information association matrix. This is another feature of the present embodiment.

### Embodiment 1

Definition of service functions of a certain enterprise and a method of defining the information flow will be explained as an embodiment of the invention with reference to the accompanying drawings. The explanation will be made in accordance with the order described above.

### <Procedure 1.1 Definition of Management Subject>

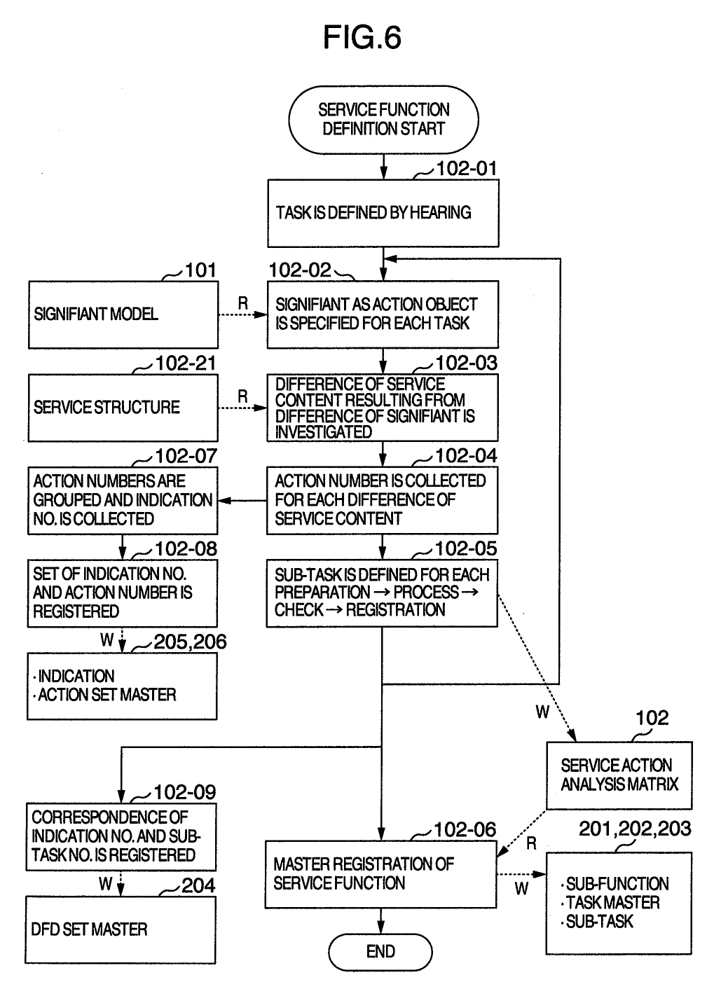

Definition of the management subject is made in accordance with the procedure shown in FIG. 4.

FIG. 4 is a flowchart showing the procedure of the definition of the management subject in this embodiment. To begin with, the management subject of the service as the object of design is selected from the eight management subjects 101-11 described already (101-01) and information related to the structure of the actual management resources of the enterprise is acquired by hearing investigation, etc (101-12). The hierachical structure of the management subject is modeled by using this information as input information (101-02) and the management model 101 is generated as the output of modeling and is stored in a storage device.

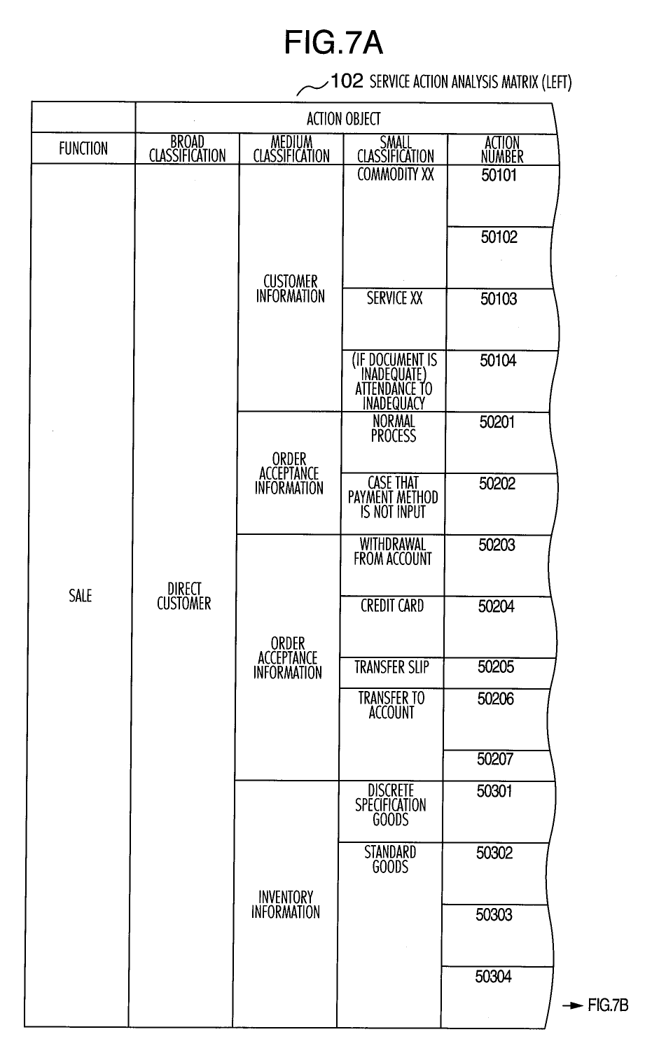

FIG. 5 is a table showing an example of the management subject model 101 according to this embodiment. FIG. 5 shows an example of the management subject model in the payment of a certain product group. Incidentally, the format of the management subject model 101 (as to which elements are to be arranged on the transverse axis and the longitudinal axis) is not fixed because it is decided in accordance with the feature of the management resources that each enterprise has.

### <Procedure 1.2 Definition of Service Function>

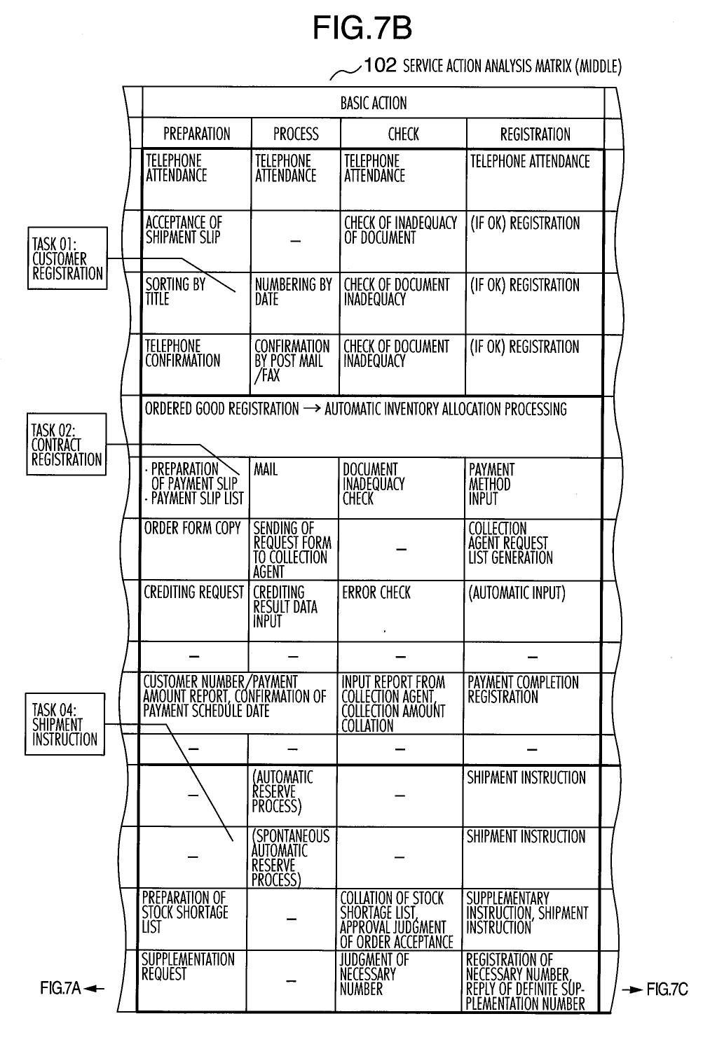

Definition of the service function is executed in accordance with the procedure shown in FIG. 6.

FIG. 6 is a flowchart showing the procedure of the service function definition in this embodiment. First of all, the result of the hearing investigation for the current service is accepted from the input device and the service function “task” is defined in accordance with the afore-mentioned hierarchy definition of the service function (102-01) and is stored in the storage device.

Next, the management subject model 101 generated in the procedure 1.1 is read from the storage device and specifies the management subject as the action object of the task for each task (102-02). The hearing result of the current service structure 102-21 is accepted from the input device and the investigation result as to which case (difference) occurs in the service content depending on the difference of the management subject is accepted from the input column of the preparation, process, check and registration (102-03) and the action number is collected for each case (difference) of the service content and is stored in the storage device (102-04).

Next, as to the result of the hearing investigation, the flow of the service is decomposed into the four steps of “preparation→(input)→processing (process)→check→registration (output)” for each action number adopted, is defined as the sub-task and is written into the service action analysis matrix 102 (102-05). Also, the service function (task, sub-task) is registered to various kinds of masters (201, 202, 203) (102-06). The flow (102-02 to 102-05) up to this stage is repeated for each task and registration is made to all the tasks.

The above explains the flow of registration of various kinds of masters (201, 202, 203) about the service action analysis matrix 102 and the service function (task, sub-task).

On the other hand, the procedure for picking up and displaying only an arbitrary action from the information association matrix as the final product of the work using the technology of this embodiment will be explained. First of all, a plurality of action numbers to be simultaneously displayed among the action numbers adopted is selected (102-07). One indication number is adopted for this group and a set of the indication number (one) and the action numbers (plural) is registered to the master 205 and the action set master 206 (102-08).

All the sub-tasks with which the action numbers (plural) corresponding to one indication number are related are specified and the correspondence between the indication number (one) and the sub-tasks (plural) is registered to the DFD set master 204 (102-09).

The above explains the work about the definition of the service function.

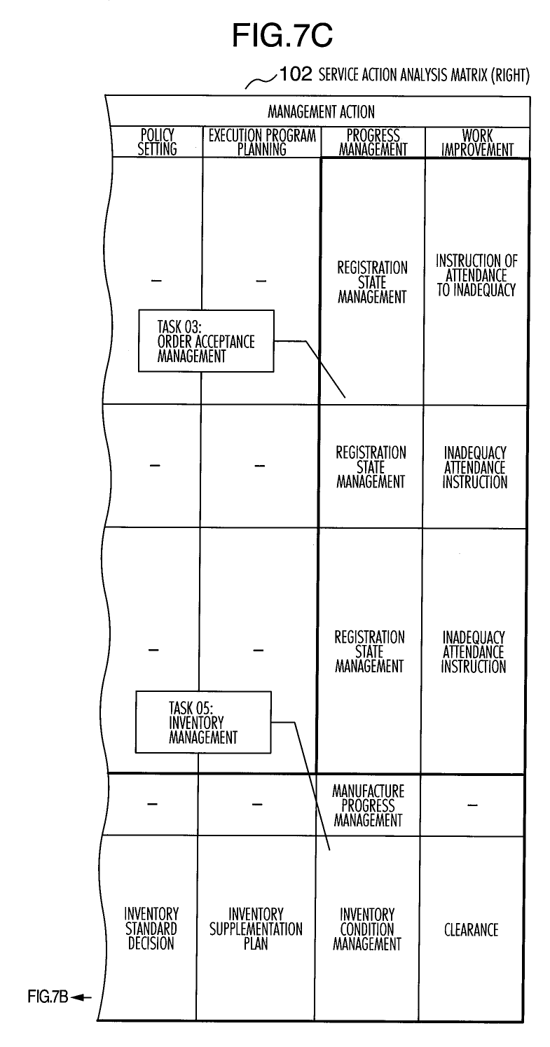

FIG. 7 shows an example of the service action analysis matrix 102 in this embodiment. The drawing shows an example of the service action analysis matrix of registration of customer information in the sale of products, order acceptance information, shipment instruction, and so forth.

### <Procedure 1.3 Definition of Action>

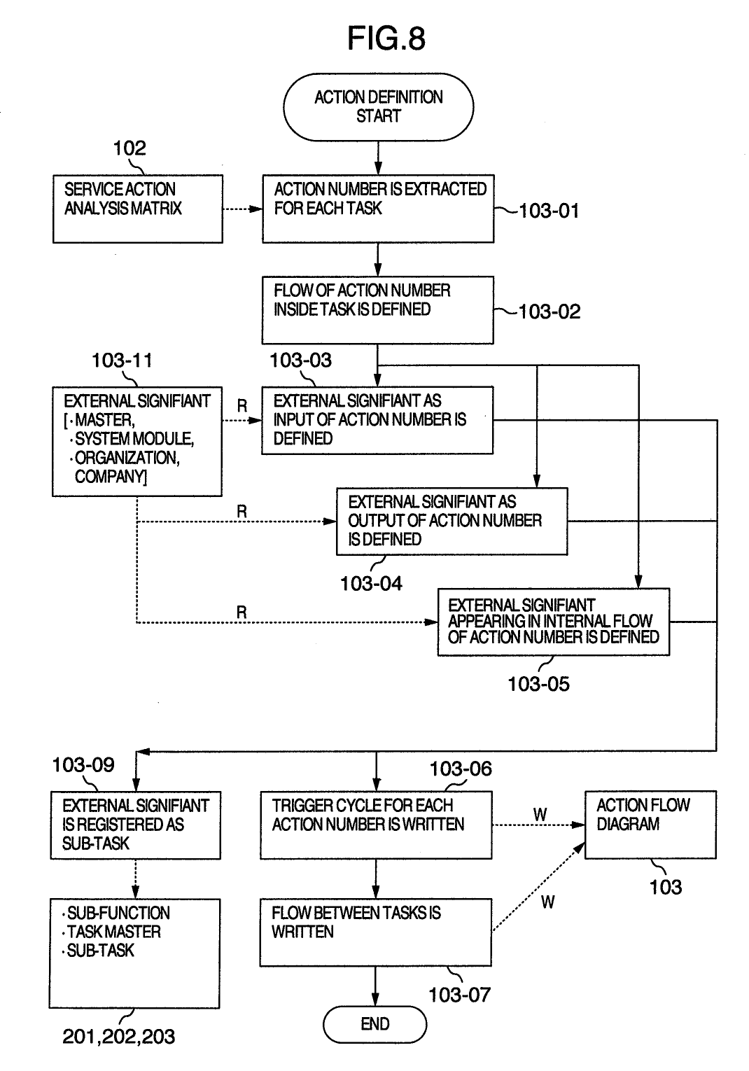

Definition of the action is executed in accordance with the procedure shown in FIG. 8.

FIG. 8 is a flowchart showing the procedure of the action definition in this embodiment. First, the action number is taken out from the storage device for each task (103-01) from the business action analysis matrix 102 generated in the procedure 1.2 and the flow of the business of a plurality of action numbers inside the task is defined (103-02).

Next, the external subject as the input of the action (information transmitting party as a trigger of the action) is defined for each action number (103-03). Here, the term “external subject” hereby used means master, in-house organization, external organization, enterprise, and so forth (103-11). The external subject as the output of the action (information outputting party from the action) is defined for each action number in the same way as the step 103-02 (103-04). Furthermore, an external subject appearing in the four flows of one action number (preparation→processing→check→registration) is defined (103-05). The procedures up to this step (103-3 to 103-05) are repeated for each task and are executed for all the tasks.

Next, the matter that operates as the trigger for the start of action of each action number and the cycle in which the matter occurs (e.g. any time, every day, every month, etc) are defined (103-06). Finally, the flow of the services of mutually different tasks is defined (103-07) and the action flow 103 is completed.

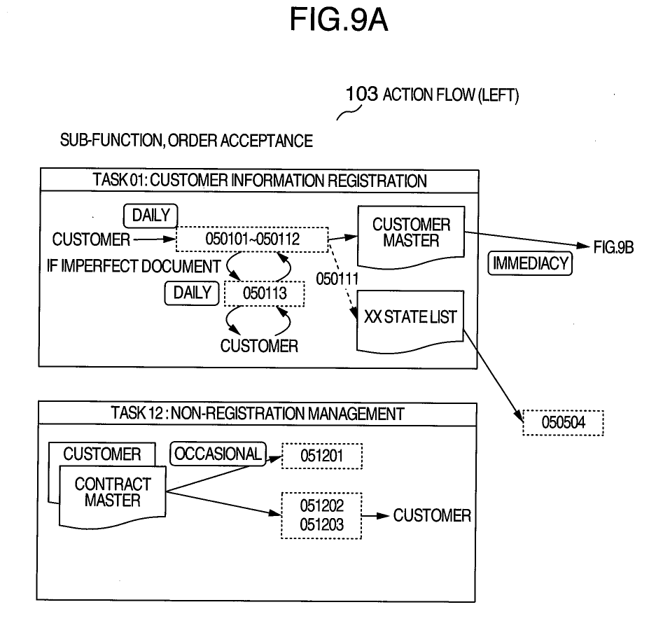

FIG. 9 is a flowchart showing an example of the action flow in this embodiment. The flowchart represents the flow of the tasks such as customer information registration in the sub-function “order acceptance”, contract information registration, payment information registration, and so forth.

As the master registration work, the external subject defined in the action definition described above is registered to various kinds of masters (201, 202, 203) relating to the service function in the same way as the sub-task.

“Procedure 1 Grasping and designing of in-house enterprise” is thus completed.

### <Procedure 2.1 Definition of Information Flowing Among Sub-Tasks>

Next, the flow for investigating the flow of information and storing the result in the action master 207 will be described.

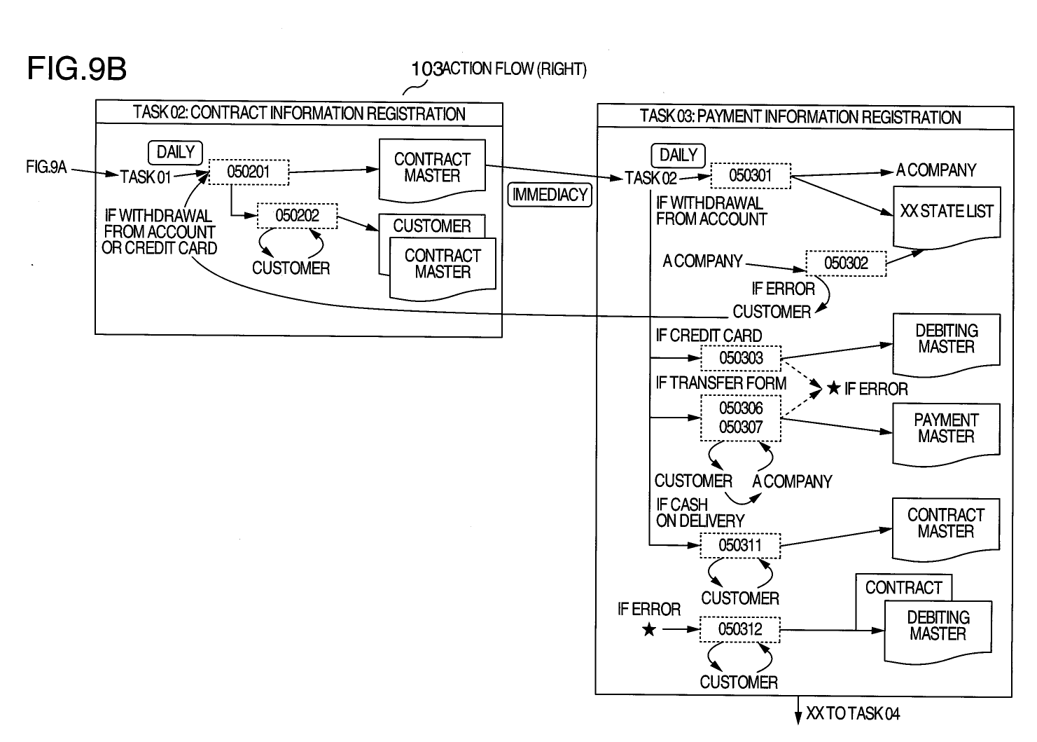

FIG. 10 is a flowchart showing the procedure of the information investigation in this embodiment. First, the sub-tasks are registered to the action master 207 in the order of the flow of action for each action number from the service action analysis matrix (108-01). In this instance, not only the flow of the sub-tasks inside the task that can be understood from the service action analysis matrix 102 but also the external subject that becomes the input and output of each action from the action flow 103 are registered to the action master 207 in the same way as the sub-tasks.

Next, the name of the information flowing among the sub-tasks is registered to the action master 207 (108-02, 03). The action master 207 is completed by these works and the information registration work in this embodiment is completed.

### <Procedure 2.2 Generation of Information Association Matrix>

Next, the flow by which the system of this embodiment executes the information process by its processing unit by utilizing the information owing to the master and table registration up to the procedure 2.1 and outputs the information association matrix as the final output product of the system of this embodiment will be explained.

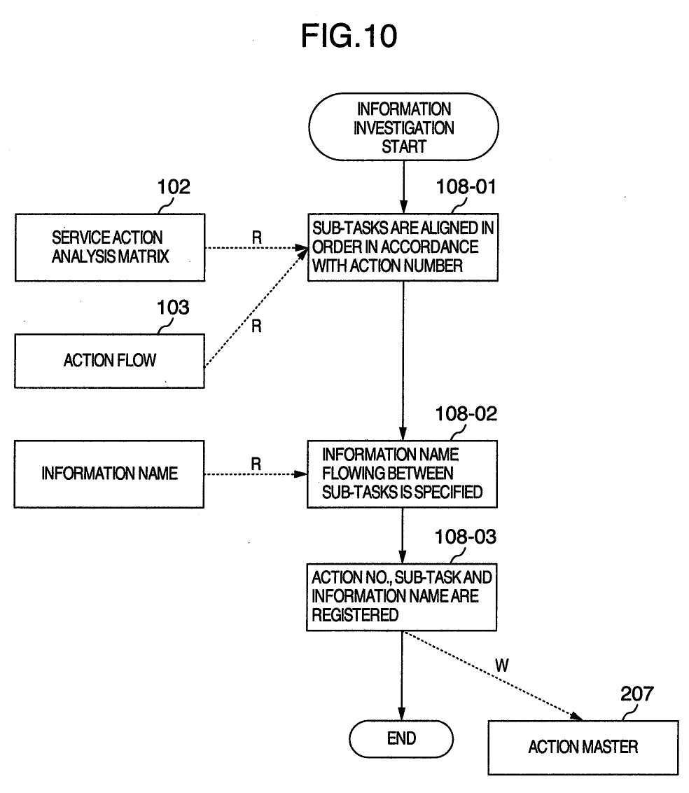

FIG. 11 is a flowchart showing the process of a DFD number collection program in this embodiment. First, the DFD number collection program 211 operates. In the process by this program, a DFD number corresponding to the indication number displayed on the information association matrix designated by the control table 221 is extracted from the second column 204-02 of the DFD set master 204 and is stored in the fifth column 203-05 of the sub-task master 203 (211-01 to 03).

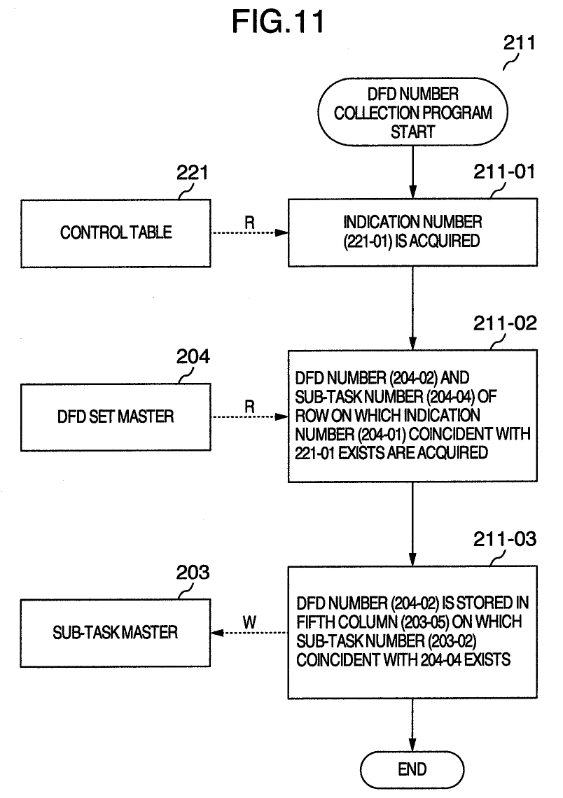

FIG. 12 is a flowchart showing the process of an action number extraction program in this embodiment. Next, the action number extraction program 212 operates. In the process by this program, an action number corresponding to the indication number displayed on the information association matrix designated by the control table 221 is extracted from the fourth row 206-04 of the action set master 206 and is stored in the setting table 222 (212-01 to 03).

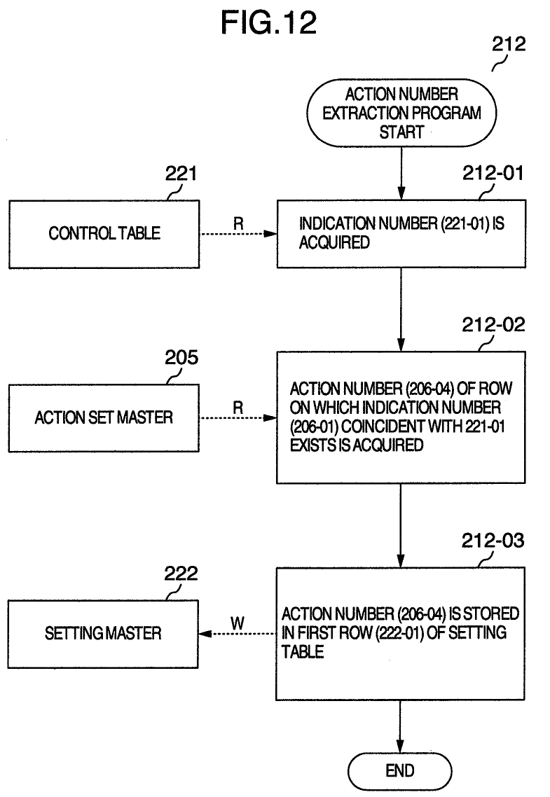

FIG. 13 is a flowchart showing the processing of a DFD diagonal setting program. In the third place, the DFD setting program 213 operates. In the process by this program, a sub-task name corresponding to the indication number displayed on the information association matrix designated by the control table 221 is extracted from the seventh row 204-07 of the DFD set master 204 and is stored in the diagonal (n-row n-column; n=1, 2, . . . ) of the information association matrix 105 (213-01 to 03).

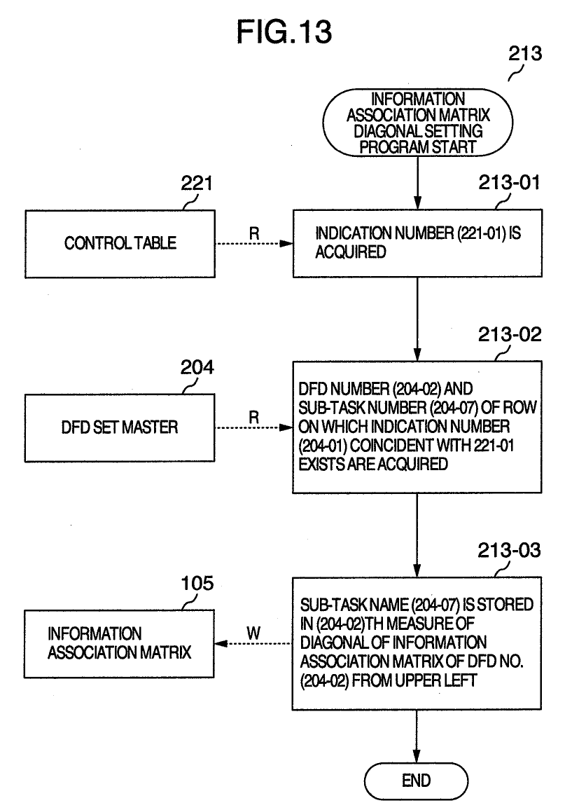

FIG. 14 is a flowchart showing the process of DFD generation program in this embodiment. Finally, the DFD generation program 214 operates. In the process by this program, an action number stored in the setting table 222 is read, an information transmitting service DFD number 207-07, an information transmitted service DFD number 207-09 and an information name 207-10 that correspond to the action number are acquired from the action master 207, and the information name is stored in (row, column=(information transmitting service DFD number, information transmitted service DFD number)) of the information association matrix 105 (214-01 to 03). In consequence, the information association matrix 105 as the plan for the flow of information among the services related to the set of arbitrary actions that are designated by the indication number as the final product to be obtained by the apparatus and the execution procedure of the embodiment can be obtained.

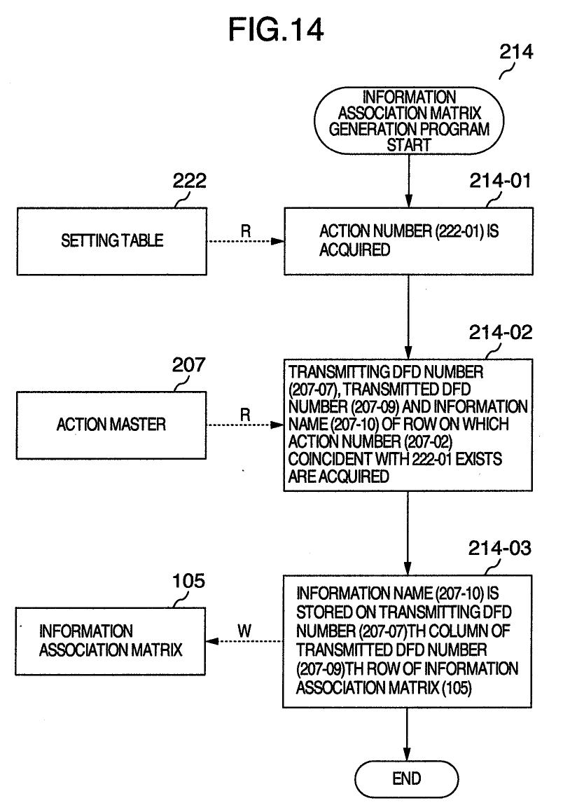

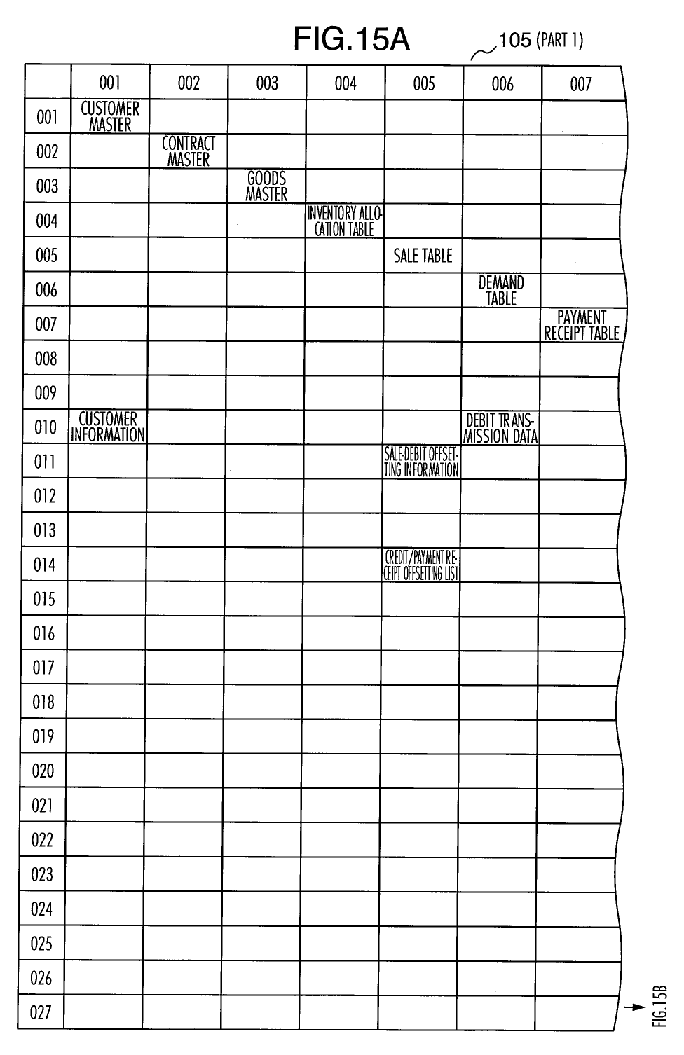

FIGS. 15A and 15B are tables showing an example of the information association matrix 105 in the embodiment. The tables show an example of the information association matrix in asset management.

In this way, “Procedure 2 Grasping and designing of flow of information among services” is completed.

### <Explanation of Master Group and Table Group>

To explain in detail the data structure as one of the important features of the embodiment, samples of the master and table group will be explained below (201 to 207, 221 and 222).

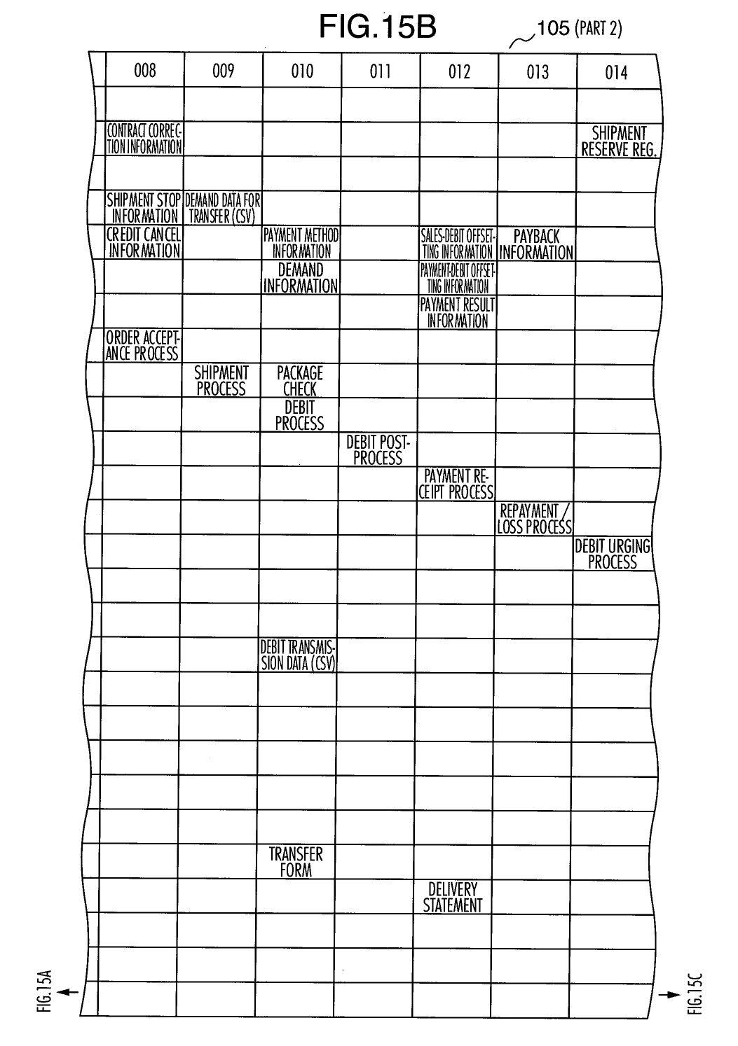

FIG. 16 is a table showing the master 201 of the service function third hierarchy “sub-function” information in the embodiment. In FIG. 16, the sub-function number 201-01 of the first column is a primary identifier and a main key.

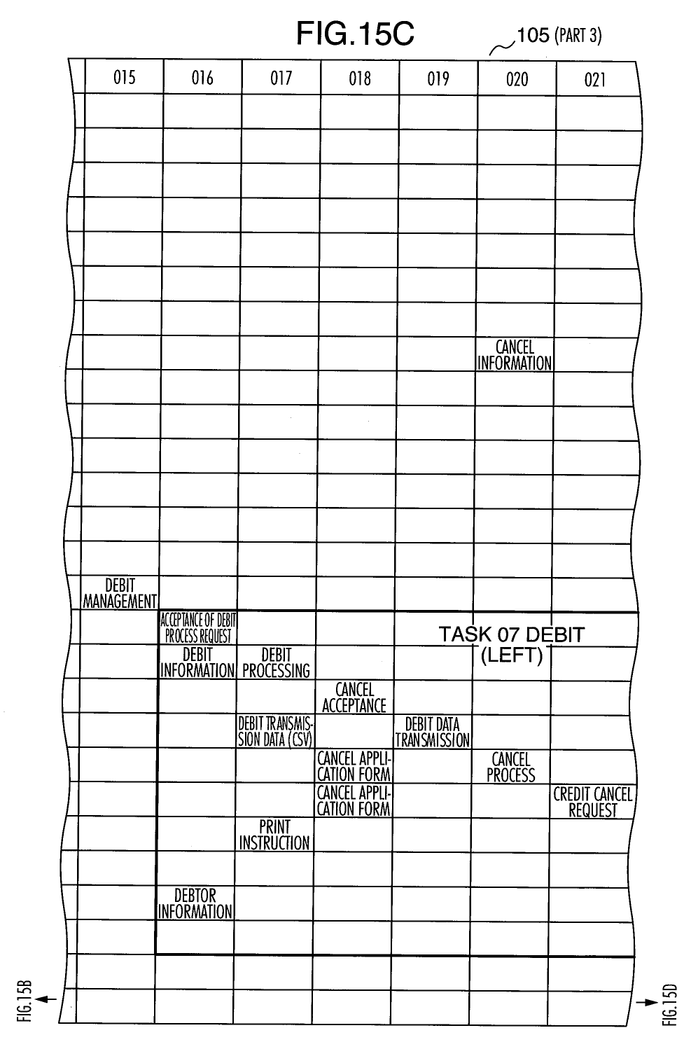

FIG. 17 is a table showing the master 202 of the service function fourth hierarchy “task” information in the embodiment. In FIG. 17, the task number 202-01 of the first column is a primary identifier and a main key. The sub-function number 202-03 of the third column represents under which sub-function the task exists and it is an external key from the first column 201-01 of the sub-function master. The fourth column is the sub-function name 202-04 generated from the sub-function master 201 by the third column sub-function number 202-03.

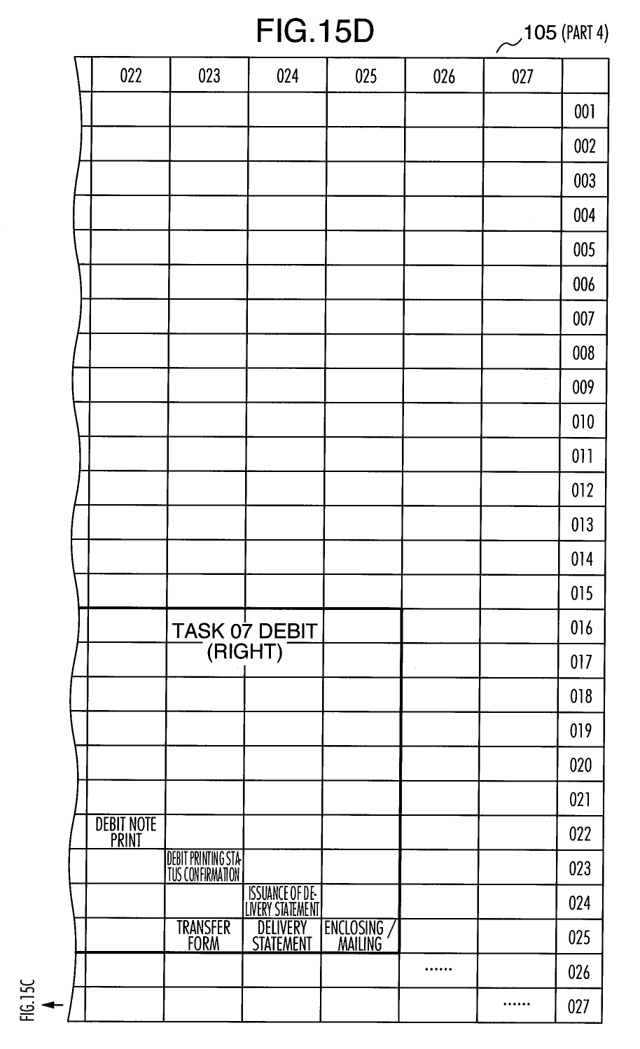

FIG. 18 is a table showing the master 203 of the service function fifth hierarchy “sub-task” information in the embodiment. In FIG. 18, the sub-task number 203-02 of the second column is a primary identifier and a main key. The number 203-01 of the first column represents under which task the sub-task exists and it is an external key from the first column 201-01 of the task master. The fifth column DFD number 203-05 is a generation item generated from the DFD set master 204 and the control table 221.

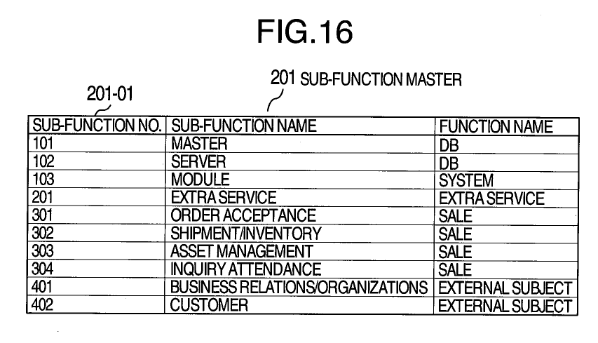

FIG. 19 is a table showing an example of the DFD set master 204 in this embodiment. FIG. 19 represents the DFD set master defining each sub-task to be displayed on the information association matrix 105 for each indication number 204-01.

Two numbers, that is, the indication number 204-01 of the first column and the DFD number 204-02 of the second column, are a composite key forming one primary identifier. However, the indication number 204-04 of the first column and the sub-task number of the fourth column are external keys from the sub-task master 203 and the other third, fifth, sixth and seventh columns (204-03, 204-05, 204-06, 204-07) are generation items derived from the sub-task master 203.

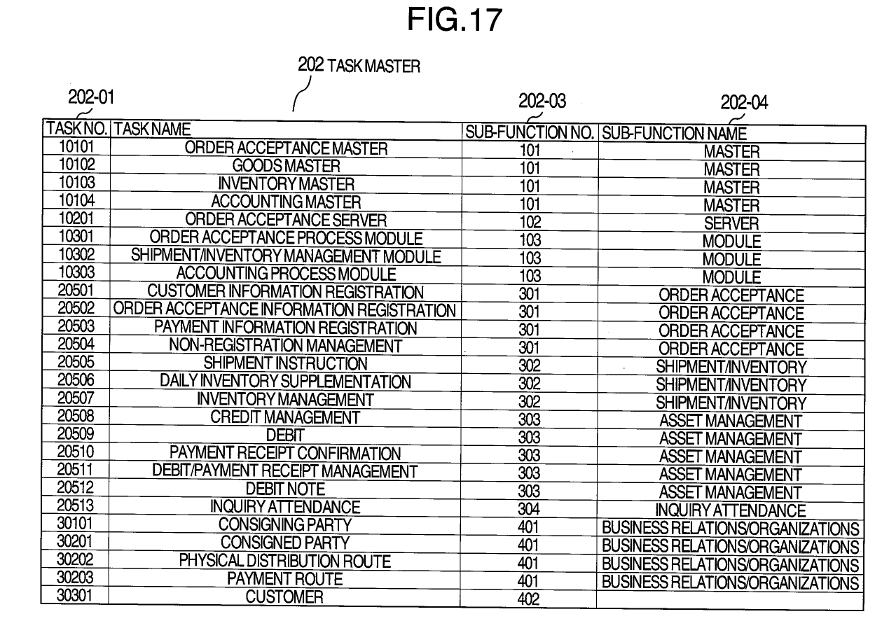

FIG. 20 is a table showing an example of the indication master 205 in this embodiment. FIG. 20 shows the indication master for defining the unit to be displayed simultaneously on the information association matrix 105. The indication number 205-01 of the first column is a primary identifier and a main key.

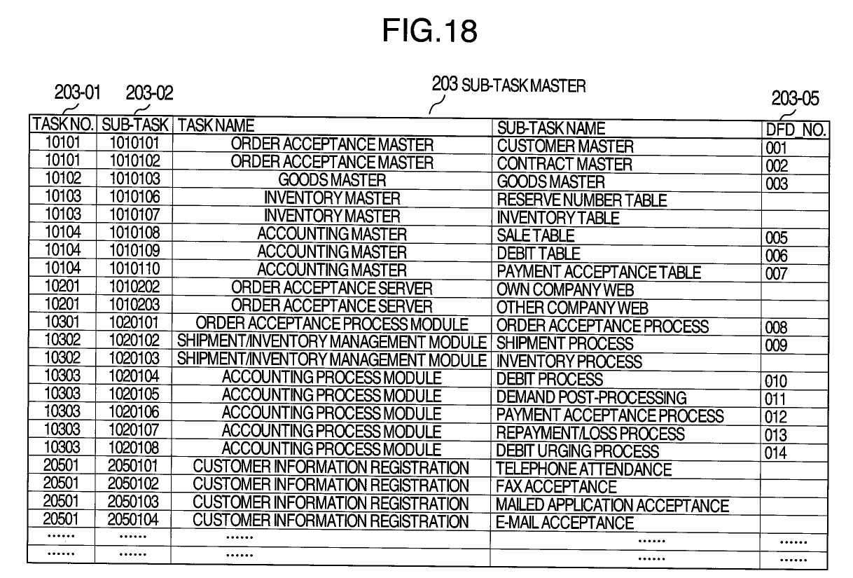

FIG. 21 is a table showing an example of the action set master 206 in this embodiment. FIG. 21 shows the action set master for defining the action to be displayed for each indication number 206-01 as the unit to be simultaneously displayed on the information association matrix 105. Two numbers, that is, the indication number 206-01 of the first column and a branch number 206-02 of the second column, are a composite key forming one primary identifier.

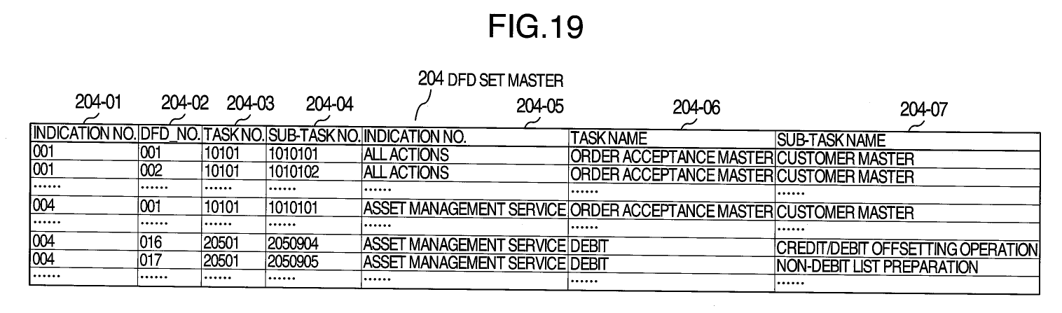

FIG. 22 is a table showing an example of the action master 207 defining the flow of information among the service functions (sub-tasks) for each action number in this embodiment. In FIG. 22, the action number 207-02 of the second column and the order 207-03 of the third column are a composite key forming one primary identifier. The fourth and fifth columns are “sub-task” numbers representing the service functions (sub-tasks) of the information transmitting party and the information destination party (207-04, 207-05) and are an external key from the sub-task master 203. The sixth to ninth columns are generation items (207-06, 207-07, 207-09) derived from the sub-task master 203. Information name 207-10 of the tenth column is the information name displayed on the information association matrix 105.

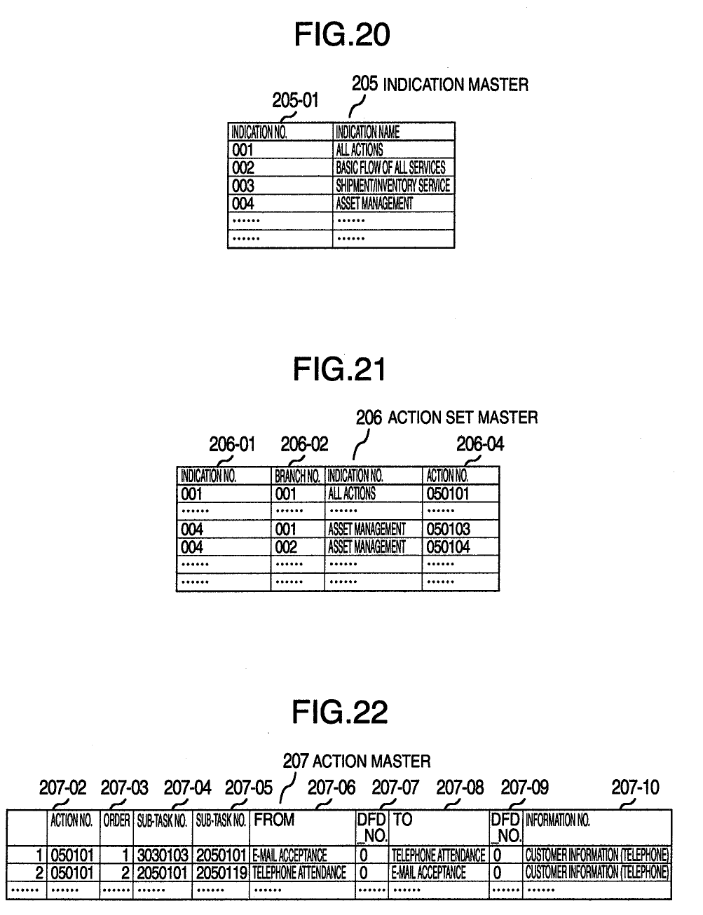

FIG. 23 is a table showing an example of the control table 221 in this embodiment. FIG. 23 shows the control table for designating the indication number 221-01 for setting the action and the service function to be displayed on the information association matrix 105.

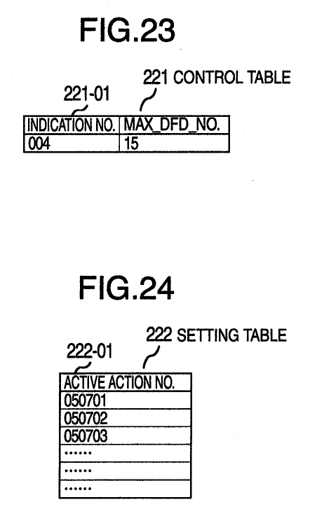

FIG. 24 is a table showing an example of the setting table 221 in this embodiment. FIG. 24 shows the setting table in which the action number corresponding to the indication number displayed on the information association matrix designated by the control table 221 when the action number extraction program 221 is operated is extracted from the fourth column 206-04 of the action set master 206 and is stored as the active action number 222-01. The table is automatically generated and is not directly operated by any human.

This embodiment provides a processing method for appropriately executing the procedures of “grasping/designing of information flow among services inside enterprise” that has been difficult and yet has been regarded as being known in the past regarding the “grasping/designing of enterprise services inside enterprise” and “grasping/designing of information flow among services” executed in service design and system basic design as the important process of in-house system configuration. As a result, the embodiment makes it possible to appropriately execute the procedure of “grasping/designing of information flow among services” by utilizing the master and the program having the data structure based on the technology of this embodiment. In this way, the processing method of the invention and the apparatus having the data structure and the program based on the processing method appropriately assist the design of the flow of information among the services inside the enterprises.

The prior art technology grasps the patterns (actions) of all the services and represents them in one sheet of information association matrix. Therefore, to generate a new service flow from the information association matrix, it has been necessary to specify and sort out the flow of information related with a specific action that is desired to be known now from the flow of the information of all the actions. Because this is a very difficult work, whether or not a new service flow can be generated from the information association matrix, even if this matrix can be generated, greatly depends on the personal capability (perception and experience) of a designer (system engineer). For this reason, the deigning method is not suitable for those services in which information association is complicated.

This embodiment makes it possible to designate a plurality of actions, to pick up the flow of information related with the actions and to output them to the information association matrix. In consequence, a sorting work for generating the service flow from the information association matrix becomes unnecessary and the service flow for each action scene can be generated by far more easily. Therefore, the embodiment can design the flow of services and information for those services having complicated information association among the services. This is very effective means for break-down from the service design to the system basic design.

As explained above, the information association matrix generation apparatus according to the embodiment stores the information by using the action number collected for a plurality of sub-tasks and generates the information association matrix. Therefore, the embodiment can establish a method of appropriately grasping and designing the services when service design is made.

It should be understood by those skilled in the art that the foregoing description has been made on the embodiment of the invention and that various changes and modifications may be made in the invention without departing from the spirit of the invention and the scope of the appended claims.

1. An information association matrix generation method for generating an information association matrix for assisting detailed grasping of existing services in enterprise actions and detailed designing of new services by utilizing a computer, comprising the steps of:
extracting a DFD (Data Flow Definition) number corresponding to an indication number displayed on an information association matrix from a DFD set master stored in a storage device and storing said DFD number in a sub-task master inside said storage device;
extracting an action number corresponding to said indication number from an action set master stored in said storage device and storing said action number in a setting table inside said storage device;
extracting a sub-task name corresponding to said indication number from a DFD set master stored in said storage device and storing said sub-task name to a position on a diagonal of said information association matrix; and
reading an action number stored in said setting table, acquiring an information transmitting service DFD number, an information transmitted service DFD number and an information name each corresponding to said action number from an action master stored in said storage device and storing said information name at a position of said information association matrix identified by said information transmitting service DFD number and said information transmitted service DFD number.

2. An information association matrix generation method according to claim 1, which further comprises the steps of:
accepting information of a plurality of sub-tasks containing sub-tasks representing input, process and output from an input device, and collecting action numbers for identifying said plurality of sub-tasks and storing them in said storage device.

3. An information association matrix generation method according to claim 1, which further comprises the steps of:
outputting an input column for inputting said sub-tasks representing input, processing and output from an output device and assisting inputting of said plurality of sub-tasks.

4. An information association matrix generation apparatus for generating an information association matrix for assisting detailed grasping of existing services in enterprise actions and detailed designing of new services, comprising:
a DFD (Date Flow Definition) collection processing unit for extracting a DFD number corresponding to an indication number displayed on an information association matrix from a DFD set master stored in a storage device and storing said DFD number in a sub-task master inside said storage device;
an action number extraction processing unit for extracting an action number corresponding to said indication number from an action set master stored in said storage device and storing said action number to a setting table inside said storage device;
a DFD diagonal setting processing unit for extracting a sub-task name corresponding to said indication number from a DFD set master stored in said storage device and storing the sub-task name to a position on a diagonal of said information association matrix; and
a DFD generation processing unit for reading an action number stored in said setting table, acquiring an information transmitting service DFD number, an information transmitted service DFD number and an information name each corresponding to said action number from an action master stored in said storage device and storing said information name to a position of said information association matrix identified by said information transmitting service DFD number and said information transmitted service DFD number.

5. An information association matrix generation apparatus according to claim 4, which further comprises:
an input device for accepting information of a plurality of sub-tasks containing sub-tasks representing input, process and output; and
an action number storing unit for collecting action numbers for identifying said plurality of sub-tasks and storing them in said storage device.

6. An information association matrix generation apparatus according to claim 4, which further comprises:
an input assist unit for outputting an input column for inputting said sub-tasks representing input, processing and output from an output device and assisting inputting of said plurality of sub-tasks.

7. A medium storing a program for causing a computer to execute an information association matrix generation method for generating an information association matrix for assisting detailed grasping of existing services in enterprise actions and detailed designing of new services, wherein said program causes said computer to execute the steps of:
extracting a DFD (Data Flow Definition) number corresponding to an indication number displayed on an information association matrix from a DFD set master stored in a storage device and storing said DFD number in a sub-task master inside said storage device;
extracting an action number corresponding to said indication number from an action set master stored in said storage device and storing said action number in a setting table inside said storage device;
extracting a sub-task name corresponding to said indication number from a DFD set master stored in said storage device and storing said sub-task name to a position on a diagonal of said information association matrix; and
reading an action number stored in said setting table, acquiring an information transmitting service DFD number, an information transmitted service DFD number and an information name each corresponding to said action number from an action master stored in said storage device and storing said information name to a position of said information association matrix identified by said information transmitting service DFD number and said information transmitted service DFD number.
